(19) United States
(12) Patent Application Publication
(10) Pub. No.: US 2003/0128629 A1
(43) Pub. Date: Jul. 10, 2003

(54) World clock

(76) Inventor: Charles A. Stevens, Sunnyvale, CA (US)

Correspondence Address: Charles A. Stevens, PO Box 2156, Cupertino, CA, 95015, US

(21) Appl. No.: 10/036,890

(22) Filed: Jan. 4, 2002

(51) Int. Cl. G04B 19/22

(52) U.S. Cl. 368/23

(57) ABSTRACT

World Clock comprising: a hollow, translucent sphere with graphics on its surface representing the world's land masses, an opaque half sphere nested within the translucent sphere, an enclosure positioned directly below the sphere, the enclosure housing an electronic clock mechanism and associated LED display, a microprocessor and associated electronics, a gear reduced motor and a vertically oriented tube extending from the base of the enclosure through the top of said enclosure and terminating in a light bulb socket and associated light bulb located at the center of the sphere. The external surface of the sphere has a plurality of push button type switches located at major cities. When the user presses a switch, the clock display shows the current time in that city. The opaque hemisphere turns once every twenty four hours so that part of the world is in dark and part in light as defined by the time in a particular part of the world. A crescent shaped arm located outside the sphere can be swung by the user and the clock display will show the time along the longitudinal axis closest to the arm. In this way a person can know the current time in any part of the world and can realistically see the light and dark conditions of any part of the world

### BACKGROUND OF THE INVENTION

This invention relates generally to the field of clocks, and more particularly to a world Clock.

Clocks have been in existence for hundreds of years. Clocks traditionally tell time by either a mechanized assembly that turns a minute hand and an hour hand to point to printed numbers on a clock face. More recently, electronic clocks display time in a digital fashion by showing the time in numbers, either by an LCD display or an LED display.

Another type of clock has been designed to show the current time in various parts of the world as well as local time. Typically these are digital displays where a person can scroll through a menu of major cities and the time is displayed for that city.

Although these world clocks do tell the current time in major cities, they do not tell the time in any location around the globe. Additionally, these displays generally do not show what part of the world is experiencing night and which part is experiencing day. Those displays that do show night and day are all flat type displays and do not accurately and realistically communicate the effect of light and dark on planet earth.

### SUMMARY OF THE INVENTION

The primary object of the invention is To provide a clock that can help the user tell the current time locally and anywhere around the world.

Another object of the invention is to provide a clock that clearly shows which parts of the world are in sunlight and which parts of the world are in darkness.

Another object of the invention is to provide a clock that allows the user to tell the time in a major city by pressing on a spot on a globe where that city is located.

A further object of the invention is to provide a clock that allows the user to tell the time in any location around the world by swiveling a vertically disposed crescent shaped positioning arm.

Other objects and advantages of the present invention will become apparent from the following descriptions, taken in connection with the accompanying drawings, wherein, by way of illustration and example, an embodiment of the present invention is disclosed.

World Clock comprising the steps of: a hollow, translucent sphere with graphics on its surface representing the world's land masses, an opaque half sphere nested within said translucent sphere, an enclosure positioned directly below said sphere, said enclosure housing an electronic clock mechanism and associated LED display, a microprocessor and associated electronics, a gear reduced motor and a vertically oriented tube extending from the base of said enclosure through the top of said enclosure and terminating in a light bulb socket, said vertical tube entering the base of said sphere terminating in a light bulb socket capable of removably retaining a light bulb, said light bulb positioned at the center of said sphere, a stationary collar integral to the center top portion of said enclosure joining said enclosure to said sphere, a rotatable collar positioned in a slip fit fashion around said stationary collar, a crescent shaped arm attached to said rotatable collar, said rotatable collar equipped with an optical encoder and associated photo diode so that when a person swings said crescent shaped positioning arm said clock registers the current time along the longitudinal line of said arm, said half sphere terminating at its base in a centrally located tubular shaft, said tubular shaft terminating in a spur gear, said spur gear capable of interacting with a spur gear mounted on the output shaft of said gear reduced motor so that said hemisphere rotates one revolution every twenty four hours thereby creating a lighted half and an unlighted half to said translucent sphere that shows what parts of the world are in darkness and which parts of the world are in light, said translucent sphere having a plurality of momentary push button type switches located at major city locations around the world, said switches connected by electrical conductors to said microprocessor so that when a person pushes said switch said microprocessor instructs said clock to display the current time at said city location and a power cord and attached plug that powers said electrical components within said enclosure and said sphere.

The drawings constitute a part of this specification and include exemplary embodiments to the invention, which may be embodied in various forms. It is to be understood that in some instances various aspects of the invention may be shown exaggerated or enlarged to facilitate an understanding of the invention.

### BRIEF DESCRIPTION OF THE DRAWINGS

FIG. 1 is a perspective view of the world clock of the present invention

FIG. 2 is a side section view of the world clock of the present invention

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

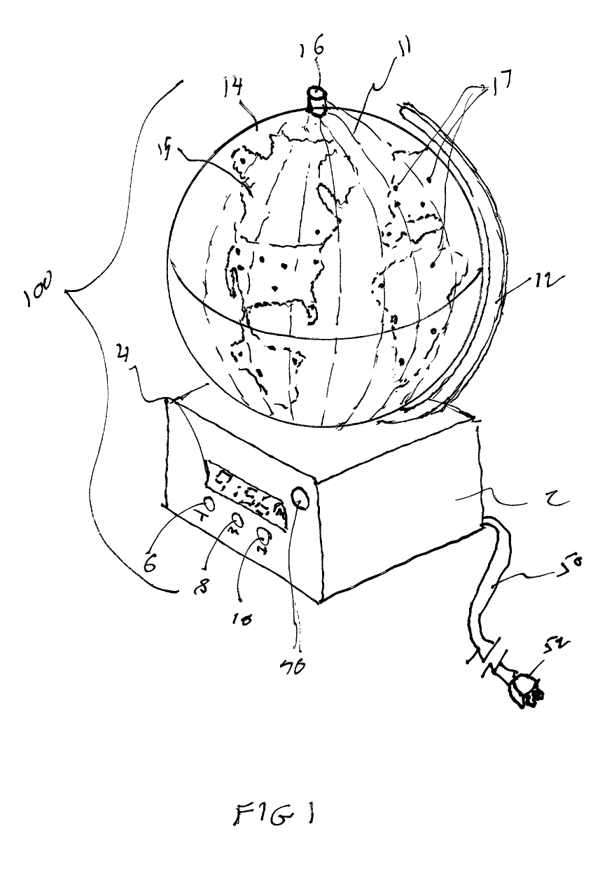

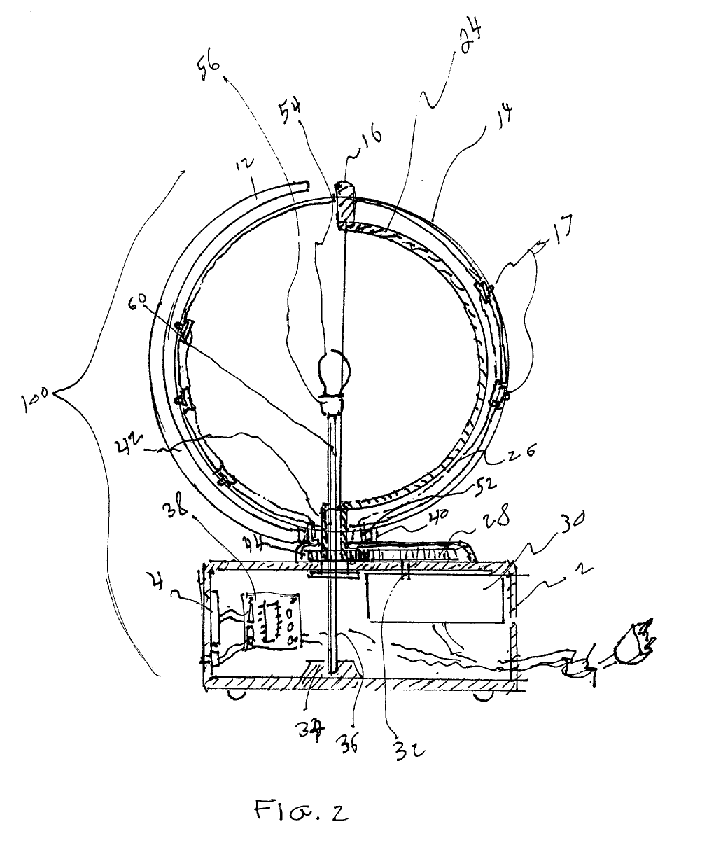

Referring now to FIG. 1 we see a perspective view of the world clock of the present invention 100. A hollow translucent sphere 14 is imprinted with a graphic 15 that represents the land masses of the world. The sphere 14 is supported by a base enclosure 2. The base enclosure includes an electronic, digital clock whose LED type display 4 can be seen on the front of the enclosure 2. The clock can be set in the standard way using the time set 6, minute set 8 and hour set 10 buttons. Push button type electrical switches 17 can be seen on the surface of the sphere 14 at major cities. Power cord 50 and plug 52 provides power to the electronic components located inside enclosure 2 and sphere 14. In FIG. 2 we see a side section view of the present invention 100. In this view we see sphere 14 supported by fixed collar 52 and attached to enclosure 2. Within sphere 14 can be seen a half sphere 24 which is made of opaque material such as plastic or metal. The half sphere has an integral tubular shaft 42 at its base and terminates in an integral spur gear 44 that interacts with a second spur gear 28 that is attached to the output shaft 32 of a gear reduced motor 30 so that the half sphere is driven at a rate of one revolution every twenty four hours. A tubular supporting stand travels from the base of enclosure 36 through the top of the enclosure 2 and through the hollow portion of the attached half sphere tubular shaft and terminates in a light bulb socket 56. Electrical conductors 60 power light bulb 54. When light bulb 54 is lit, the half sphere blocks the light to half the outer sphere 14 creating the effect of the sun hitting the world where one half of the world is in light and one half is in darkness. This effect is helpful when a person is looking at the globe 14 and can see at a glance what areas are in daylight and what areas are experiencing night. Push button switches 17 are located at major cities and are connected by wires 26 to microprocessor 38. Microprocessor 38 coordinates the time zones so that when a person pushes a button at a major city, the microprocessor takes into account the current local time and computes the current time at the city which may be half way around the world. For locations that are not covered by push button switches the user can swing crescent shaped arm 12 to the longitude 11 that the location is at. The arm 12 terminates at its base in a slip fit collar 40 that includes an encoder graphic and a photo diode pickup that is a standard means of digitally determining a position of a rotating member. The encoder information is fed to the microprocessor 38 which interprets the location and translates it into a time factor when the user presses the world time button 70 located at the top right corner of the face of the enclosure 2. It is to be understood that the crescent arm's location may be determined by other known indexing means. Top knob 16 is integral to half sphere 24 and can be used to manually turn the half sphere to the location that corresponds to setting up the light and dark conditions at the current time and location of the user.

In the above described and illustrated way the world clock of the present invention shows a person the current time and daylight or night conditions as well as the current time at any location around the world. The spherical shape of the world map shows the light and dark conditions more accurately and realistically than a flat representation of the world.

While the invention has been described in connection with a preferred embodiment, it is not intended to limit the scope of the invention to the particular form set forth but on the contrary, it is intended to cover such alternatives, modifications, and equivalents as may be included within the spirit and scope of the invention as defined by the appended claims.

What is claimed is:

1. World Clock comprising:
a hollow, translucent sphere with graphics on its surface representing the world's land masses;
an opaque half sphere nested within said translucent sphere;
an enclosure positioned directly below said sphere;
said enclosure housing an electronic clock mechanism and associated LED display, a microprocessor and associated electronics, a gear reduced motor and a vertically oriented tube extending from the base of said enclosure through the top of said enclosure;
said vertical tube entering the base of said sphere terminating in a light bulb socket capable of removably retaining a light bulb;
said light bulb positioned at the center of said sphere;
a stationary collar integral to the center top portion of said enclosure joining said enclosure to said sphere;
a rotatable collar positioned in a slip fit fashion around said stationary collar;
a crescent shaped arm attached to said rotatable collar;
said rotatable collar equipped with an optical encoder and associated photo diode or other known indexing means so that when a person swings said crescent shaped positioning arm said clock registers the current time along the longitudinal line of said arm;
said half sphere terminating at its base in a centrally located tubular shaft;
said tubular shaft terminating in a spur gear;
said spur gear capable of interacting with a spur gear on the output shaft of said gear reduced motor so that said hemisphere rotates one revolution every twenty four hours thereby creating a lighted half and an unlighted half to said translucent sphere that shows what parts of the world are in darkness and which parts of the world are in light;
said translucent sphere having a plurality of momentary push button type switches located at major city locations around the world;
said switches connected by electrical conductors to said microprocessor so that when a person pushes said switch said microprocessor instructs said clock to display the current time at said city location; and
a power cord and attached plug that powers that said electrical components within said enclosure and said sphere.
